(19) United States
(12) Patent Application Publication
(10) Pub. No.: US 2003/0165037 A1
(43) Pub. Date: Sep. 4, 2003

(54) Three-phase supervisory circuit

(76) Inventor: Stephen Liscinksy, Stratford, CT (US)

Correspondence Address: Roylance, Abrams, Berdo & Goodman, L.L.P., Suite 600, 1300 19th Street, N.W., Washington, DC, 20036, US

(21) Appl. No.: 10/085,138

(22) Filed: Mar. 1, 2002

(51) Int. Cl. H02H 3/18

(52) U.S. Cl. 361/78

(57) ABSTRACT

An apparatus and method for detecting fault conditions in an input AC power signal. A three phase supervisory circuit is used to detect the fault conditions and comprises first, second and third sensing circuits for detecting a voltage level for respective phases of the AC power signal. The three phase supervisory circuit compares the voltage levels to a threshold value. A delay circuit delays operation of the sensing circuits for a predetermined period of time. An activation circuit for receiving indication signals from the sensing and delay circuits is also used. The indication signals are indicative of whether the predetermined period of time has elapsed and the three voltage levels of the three phases have met the threshold value.

### FIELD OF THE INVENTION

The present invention relates to a method and apparatus for monitoring a three phase power signal for a change in operating conditions. More particularly, the invention relates to a three phase supervisory circuit for detecting phase reversal, phase loss, open neutral and undesirable changes in phase voltage level.

### BACKGROUND OF THE INVENTION

Three-phase inductive motors, as well as many other three-phase loads, are often inoperable or susceptible to damage due to power supply faults such as power loss, phase loss, and phase reversal. More specifically, a momentary power loss allows a motor to decelerate which increases the degree of slip between the rotor and the alternating current passing through the stator. Upon restoration of power, the rotor tries to quickly recover its original slip relationship with the current. In the rotor's attempt to do so, high torques are developed which can damage the rotor shaft or other components associated with it.

With a phase loss condition, current is supplied to the motor through only two of the three supply lines. When this happens, the motor tries to compensate for the inactive phase by conducting additional current through the stator windings which are connected to the remaining two active phases. As a result of the additional current, the active windings can overheat to a potentially destructive high temperature.

In reaction to a phase reversal, often referred to as reverse phase rotation, the motor rotates in a direction opposite to its normal rotation. This is often caused by improperly matching the motor leads to the power supply. Depending on the specific application, reverse rotation can make a critical motor driven oil pump inoperative or unscrew an impeller from a threaded drive shaft, either of which can cause extensive damage.

Although a wide variety of fault detectors for use in three-phase circuits are presently available, these detectors typically detect only one type of fault. Moreover, in many applications, their timely response to faults is inadequate. Some detectors respond too slowly to critical faults such as a momentary power loss, where damage can quickly occur if the detector does not interrupt the power supply before power is restored. Other detectors respond too quickly to less critical faults where a slower response is desirable to reduce the effects of false readings due to electrical noise, for example. Still other detectors often include many electrical components which not only increase the cost of the detector but are often unnecessary.

Therefore, a need exists for a detector that responds to more than one input voltage fault. In addition, the detector should be able to operate within a reasonable time upon detection of the input voltage fault.

### SUMMARY OF THE INVENTION

The above and other objectives are substantially achieved by an apparatus and method employing a three phase supervisory circuit for monitoring an AC input signal and outputing an AC signal if the AC input signal meets the required conditions.

The three phase supervisory circuit comprises first, second and third sensing circuits for detecting a voltage level for respective phases of the AC power signal. The three phase supervisory circuit compares the voltage levels to a threshold value. A delay circuit delays operation of the sensing circuits for a predetermined period of time. An activation circuit for receiving indication signals from the sensing and delay circuits is also used. The indication signals are indicative of whether the predetermined period of time has elapsed and the three voltage levels of the three phases have met the threshold value.

### BRIEF DESCRIPTION OF THE DRAWINGS

The details of the present invention can be readily understood by considering the following detailed description in conjunction with the accompanying drawings, in which:

FIG. 1 is a schematic diagram of a three phase supervisory circuit constructed in accordance with an embodiment of the present invention; and

FIG. 2 is a schematic diagram of a three phase supervisory circuit constructed in accordance with another embodiment of the present invention; and

FIG. 3 is a flow chart of a method of monitoring an AC input signal via a three phase circuit in accordance with an embodiment of the present invention.

To facilitate understanding, identical reference numerals have been used, where possible, to designate identical elements that are common to the figures.

### DETAILED DESCRIPTION OF THE PREFERRED EMBODIMENTS

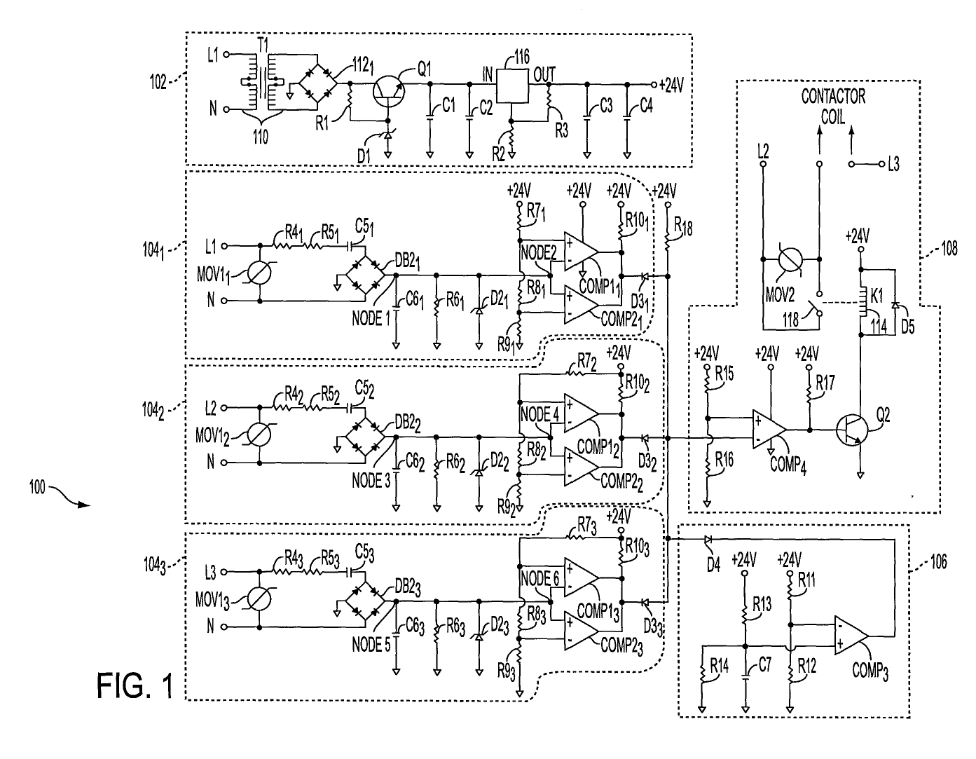

FIG. 1 depicts a three phase supervisory circuit 100 in accordance with an embodiment of the present invention and the following sub-circuits: a power supply circuit 102, a first sensing circuit 104₁, a second sensing circuit 104₂, a third sensing circuit 104₃, a delay circuit 106, and an activation circuit 108. Each one of the sub-circuits will now be discussed in detail with reference to the overall operation of the three phase supervisory circuit 100.

With continued reference to FIG. 1, the power supply circuit 102 comprises a transformer 110, a first bridge rectifier 112₁, resistors R1, R2, and R3, capacitors C1, C2, C3 and C4, diode D1, a first transistor Q1, and a voltage regulator 116. In a preferred embodiment of the present invention, the power supply circuit 102 accepts an AC input voltage via line one (L1) and neutral (N) terminals and provides 24 volts DC to the other sub-circuits. To provide a consistent 24 volt output, transformer 110 is preferably a 240 volt half-voltage transformer and operates at half-voltage. The transformer 110 provides essentially one-half the voltage on the primary and the other half of the voltage on the secondary coils of the transformer 110. This allows for robustness of the three phase supervisory circuit 100. For example, a high voltage input (e.g. 208) volts can be applied to the input of the primary coil of the transformer 110 without burning out the transformer 110 or other components of the power supply circuit 102.

The transistor Q1 and diode D1 in the power supply circuit 102 preferably serve as a pre-regulator and insures that the voltage across the capacitor C1 and voltage regulator 116 is within accepted parameters. The diode D1 is preferably a zener diode and is preferably limited to 36 volts. The 36 volts is received by the voltage regulator 116 which is preferably an adjustable voltage regulator. Adjustable voltage regulator 116 adjusts the voltage received from the transistor Q1 and reduces it to a preferably constant 24 volt output or very close to it. Adjustable voltage regulator 116 allows for a consistent output voltage even when the input voltage varies. Transformer 110, diode D1 and transistor Q1 serve to limit the value of the AC input voltage to a value that the voltage regulator 116 can accept so that the likelihood of voltage regulator 116 burning out due to a high input voltage is reduced.

The three phase supervisory circuit 100 will now be described with reference to the sensing circuits 104₁, 104₂ and 104₃. In a preferred embodiment of the invention, each of the sensing circuits comprises substantially identical electrical components and operates in a similar manner. The arrangement of their components will be discussed separately, but the operation of the sensing circuits 104₁, 104₂ and 104₃ will be discussed jointly with respect to first sensing circuit 104₁.

First sensing circuit 104₁ monitors the first phase of the input power signal. The first sensing circuit 104₁ comprises input terminals for receiving an input power source. The input terminals are designated as line one (L1) and neutral (N). A metal oxide varistor MOV1₁, a resistor R4₁, a resistor R5₁, a capacitor C5₁ and a diode bridge DB2₁ are operable as a first portion of a voltage divider circuit for first sensing circuit 104₁.

Resistors R4₁, R5₁, capacitor C5₁ and diode bridge DB2₁ are connected in series. Resistors R4₁ and R5₁ operate as surge protectors. Capacitor C5₁ preferably has an impedance of 60 Hz and is part of the resistance network. The metal oxide varistor MOV1₁ provides the first sensing circuit 104₁ with protection against electrical spikes contained in the input signal. The bridge rectifier circuit DB2₁ provides a 12 volt output at node one based on an input voltage of 120 volts at terminals L1 and N. At node one, a capacitor C6₁, resistor R6₁ and diode D2₁ are connected in parallel and terminate at a node two and comprise a second portion of a voltage divide circuit for first sensing circuit 104₁.

First sensing circuit 104₁ also comprises a comparator circuit. The comparator circuit comprises comparator COMP1₁ and comparator COMP2₁. Each comparator COMP1₁ and COMP2₁ has a positive input terminal, a negative input terminal and an output terminal. The negative terminal of comparator COMP1₁ and the positive terminal of comparator COMP2₁ are connected together at node two. The positive and output terminals of comparator COMP1₁ are connected to resistor R7₁, R8₁ and R10₁. The negative and output terminals of comparator COMP2₁ are connected to resistor R8₁, resistor R9₁ and resistor R10₁. A diode D3₁ is disposed at the outputs of the comparators COMP1₁ and COMP2₁.

Second sensing circuit 104₂ monitors the second phase of the input power signal. The second sensing circuit 104₁ comprises input terminals for receiving an input power source. The input terminals are designated as line two (L2) and neutral (N). A metal oxide varistor MOV1₂, a resistor R4₂, a resistor R5₂, a capacitor C5₂ and a diode bridge DB2₂ are operable as a first portion of a voltage divider circuit for second sensing circuit 104₂.

Resistors R4₂, R5₂, capacitor C5₂ and diode bridge DB2₂ are connected in series. Resistors R4₂ and R5₂ operate as surge protectors. Capacitor C5₂ preferably has an impedance of 60 Hz and is part of the resistance network. The metal oxide varistor MOV1₂ provides the second sensing circuit 104₂ with protection against electrical spikes contained in the input signal. The bridge rectifier circuit DB2₂ provides a 12 volt output at node three based on an input voltage of 120 volts at terminals L2 and N. At node three, a capacitor C6₂, resistor R6₂ and diode D2₂ are connected in parallel and terminate at a node four and comprise a second portion of a voltage divide circuit for second sensing circuit 104₂.

Second sensing circuit 104₂ also comprises a comparator circuit. The comparator circuit comprises comparator COMP1₂ and comparator COMP2₂. Each comparator COMP1₂ and COMP2₂ has a positive input terminal, a negative input terminal and an output terminal. The negative terminal of comparator COMP1₂ and the positive terminal of comparator COMP2₂ are connected together at node four. The positive and output terminals of comparator COMP1₂ are connected to resistor R7₂, R8₂ and R10₂. The negative and output terminals of comparator COMP2₂ are connected to resistor R8₂, resistor R9₂ and resistor R10₂. A diode D3₂ is disposed at the outputs of the comparators COMP1₂ and COMP2₂.

Third sensing circuit 104₃ monitors a third phase of the input power signal. The third sensing circuit 104₃ comprises input terminals for receiving an input power source. The input terminals are designated as line three (L3) and neutral (N). A metal oxide varistor MOV1₃, a resistor R4₃, a resistor R5₃, a capacitor C5₃ and a diode bridge DB2₃ are operable as a first portion of a voltage divider circuit for third sensing circuit 104₃.

Resistors R4₃, R5₃, capacitor C5₃ and diode bridge DB2₃ are connected in series. Resistors R4₃ and R5₃ operate as surge protectors. Capacitor C5₃ preferably has an impedance of 60 Hz and is part of the resistance network. The metal oxide varistor MOV1₃ provides the third sensing circuit 104₃ with protection against electrical spikes contained in the input signal. The bridge rectifier circuit DB2₃ provides a 12 volt output at node five based on an input voltage of 120 volts at terminals L3 and N. At node five, a capacitor C6₃, resistor R6₃ and diode D2₃ are connected in parallel and terminate at a node six and comprise a second portion of a voltage divide circuit for third sensing circuit 104₃.

Third sensing circuit 104₃ also comprises a comparator circuit. The comparator circuit comprises comparator COMP1₃ and comparator COMP2₃. Each comparator COMP1₃ and COMP2₃ has a positive input terminal, a negative input terminal and an output terminal. The negative terminal of comparator COMP1₃ and the positive terminal of comparator COMP2₃ are connected together at node six. The positive and output terminals of comparator COMP1₃ are connected to resistor R7₃, R8₃, and R10₃. The negative and output terminals of comparator COMP2₃ are connected to resistor R8₃, resistor R9₃ and resistor R10₃. A diode D3₃ is disposed at the outputs of the comparators COMP1₃ and COMP2₃.

The operation of sensing circuits 104₁, 104₂ and 104₃ will now be discussed. The sensing circuits 104₁, 104₂ and 104₃ each monitor a phase of an input AC signal. The voltage level of the AC input signal is also monitored. In a preferred embodiment of the invention, the AC input signal is 120 volts. If the AC input signal is wired correctly, that is, each line is wired to a neutral and not to other lines, the input voltage is 120 volts. If the AC input voltage is wired incorrectly, the input voltage can be much greater than 120 volts. However, the sensing circuits 104₁, 104₂ and 104₃ can detect this difference in voltage and react to the abnormal condition in a manner described below with respect to the activation circuit 108.

For each sensing circuit 104, the corresponding diode bridge DB2 converts the AC input signal into a 12 volt DC signal if the AC input voltage is 120 volts. If the diode bridge DB2 outputs a different value, then it indicates that the input value was not 120 volts. Diode D2, which is preferably a zener diode, limits the DC voltage going to the comparators COMP1 and COMP2 to preferably 20 volts. Any voltage higher than 20 volts DC causes the diode D2 to limit the voltage to no more than 20 volts which protects the comparators COMP1 and COMP2. For example, if there is a miswire condition and lines N and L2 are reversed, the voltage across diode D2 can be as high as 36 volts.

The comparators COMP1 and COMP2 compare the voltage from diode DB2 to about a 12 volt reference voltage. If the voltage from the diode DB2 is not about 12 volts, then the comparators COMP1 and COMP2 send a negative indication signal to the activation circuit 108 which indicates that the correct voltage level was not received. If the correct voltage level was received, then a positive indication would be sent by the comparators COMP1 and COMP2 to the activation circuit 108.

For the three sensing circuits 104₁, 104₂ and 104₃, diodes D3₁, D3₂ and D3₃ are each connected to resistor R18. The three sensing circuits 104₁, 104₂ and 104₃ operate as inputs to logic AND gates. In other words, all three sensing circuits preferably must have the proper voltage levels before the activation circuit 108 can receive a positive indication.

The three phase circuit 100 will now be described with reference to delay circuit 106. Delay circuit 106 comprises a comparator COMP3 having a negative terminal, a positive terminal and an output terminal. The negative terminal of comparator COMP3 is connected to resistor R11 and resistor R12 and receives 24 volts DC from power supply circuit 102. The positive terminal of comparator COMP3 is connected to resistor R13, resistor R14 and capacitor C7 and receives 24 volts DC from the power supply circuit 102. The output of comparator COMP3 is connected to a diode D4 which is in turn connected to resistor R18.

Delay circuit 106 preferably provides an approximately one to two second delay when three phase supervisory circuit 100 is first powered up. The one to two second delay allows the capacitors in the three phase supervisory circuit 100 to stabilize. Once the delay period is over, diode D4 sends a positive indication signal to the activation circuit 108.

The activation circuit 108 includes a comparator COMP4 having a negative terminal, a positive terminal and an output. The negative and output terminals of comparator COMP4 are connected to resistor R15, resistor R16, and resistor R17. The negative terminal of comparator COMP4 is connected to resistor R18. A transistor Q2 is also connected to the output terminal of comparator COMP4. A relay coil K1, diode D5, relay 118 and metal oxide varistor MOV2 are also connected to transistor Q2. The metal oxide varistor MOV2 is in turn connected to a contactor coil (not shown).

The activation circuit 108 receives indication signals from the sensing circuits 104₁, 104₂ and 104₃ and from the delay circuit 106. If the phase and voltage levels are correct for the AC input signal, then each of the sensing circuits 104₁, 104₂ and 104₃ provide a positive indication to the activation circuit 108. Delay circuit 106 also provides a positive indication signal once the delay period is over. Specifically, comparator COMP4 receives positive indication signals from the sensing circuits 104₁, 104₂ and 104₃ and delay circuit 106, and generates an output to activate the transistor Q2, which in turn activates the relay coil K1. This results in relay 118 closing and the contactor coil being powered. The metal oxide varistor MOV2 protects the three phase supervisory circuit 100 from kickbacks such as large electrical spikes when the contactor coil is powered and not powered.

In accordance with an embodiment of the invention, the contactor coil can serve as an extension cord and be connected to a plurality of ground fault circuit interrupter (GFCI) receptacles. The plurality of GFCI devices would then be protected from miswiring, phase imbalances and improper input voltage levels that exceed the normal operating range of the GFCI receptacles.

In another embodiment of the invention, the three phase supervisory circuit 100 is used as a tester by a technician to check the electrical wiring of a facility to determine the correct wiring arrangement. If the electrical wiring is wrong or the AC voltage of the wiring is incorrect, the three phase supervisory circuit will not provide an output signal.

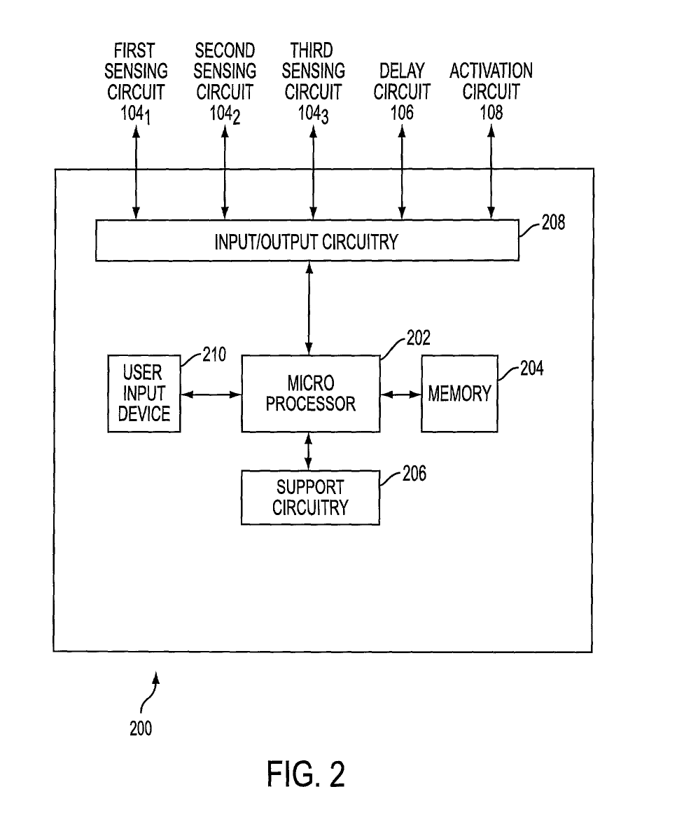

Turning to FIG. 2, an alternative embodiment for the three phase supervisory circuit 100 is depicted. Specifically, FIG. 2 depicts a programmable processor 200 suitable for use in the three phase supervisory circuit 100. The programmable processor 200 comprises a microprocessor 202, as well as memory 204 for storing programs for various timing functions. The microprocessor 202 cooperates with conventional support circuitry 206 such as power supplies, clock circuits and the like, as well as circuits that assist in executing the phase and voltage monitoring and the miswiring detection functions of the present invention. A user interface device 210 such as a keypad is provided to enter selected time out periods.

The programmable processor 200 also comprises input/output circuitry 208 that forms an interface between the microprocessor 202, power supply circuit 102, first sensing circuit 104₁, second sensing circuit 104₂, third sensing circuit 104₃, delay circuit 106, and activation circuit 108.

Although the programmable processor 200 is depicted as a general purpose computer that is programmed to perform the decision making functions of first sensing circuit 104₁, second sensing circuit 104₂, third sensing circuit 104₃, delay circuit 106 and activation circuit 108 in accordance with the present invention, the invention can be implemented in hardware, in software, or a combination of hardware and software. As such, the monitoring and detecting functions described above with respect to the various figures are intended to be broadly interpreted as being equivalently performed by software, hardware, or a combination thereof.

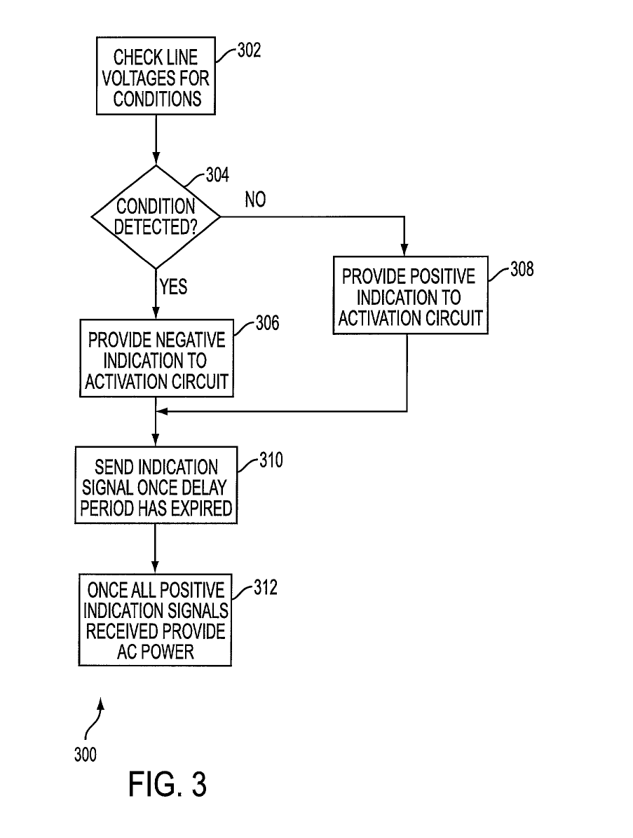

The present invention will now be discussed with reference to FIG. 3. Specifically, FIG. 3 is a flow chart of a method of monitoring a three phase circuit in accordance with an embodiment of the present invention. The method begins at step 302 where the line voltages are checked for the following conditions: detection of an open neutral in any of the AC line inputs, an open in phase one, phase two or phase three, over-voltage conditions on input phase voltages (e.g. voltages greater than 138 VAC), under-voltage on input phase voltages (e.g. voltages less than 102 VAC), a line one-to-neutral reverse wiring condition, a line two-to-neutral reverse wiring condition, a line three-to-neutral reverse wiring condition, a miswiring condition where lines one, two or three are wired together in combinations of two or three.

At step 304, a determination is made as to whether any of the above conditions or combinations of the above mentioned error conditions are detected. If the determination is positive, the method 300 proceeds to step 306 where the sensing circuits 104₁, 104₂ and 104₃ provide a negative indication signal to activation circuit 108.

However, if the determination is negative, which indicates nothing was found wrong with input voltages or wiring, the method 300 proceeds to step 308 where the sensing circuits 104₁, 104₂ and 104₃ provide a positive indication signal to activation circuit 108.

At step 310, the delay circuit provides an indication signal to the activation circuit 108 indicating that the delay period has expired and the capacitors in the three phase activation circuit 100 has stabilized.

At step 312, the activation circuit 108 provides an activation signal which opens relay 118, allowing 120 volts to be outputted from three phase supervisory circuit 100. The relay 118 can be connected to a contactor coil in an embodiment of the present invention.

Those skilled in the art can now appreciate from the foregoing description that the broad teachings of the present invention can be implemented in a variety of forms. Therefore, while this invention can be described in connection with particular examples thereof, the true scope of the invention should not be so limited since other modifications will become apparent to the skilled practitioner upon a study of the drawings, specification and the following claims.

What is claimed is:

1. A three phase supervisory circuit for detecting fault conditions in an input AC power signal, comprising:
a first sensing circuit for detecting a voltage level for a first phase of said AC power signal and comparing said voltage level of said first phase to a threshold value;
a second sensing circuit for detecting a voltage level for a second phase of said AC power signal and comparing said voltage level of said second phase to said threshold value;
a third sensing circuit for detecting a voltage level for a third phase of said AC power signal and comparing said voltage level of said third phase to said threshold value;
a delay circuit for delaying operation of said sensing circuits for a predetermined period of time; and
an activation circuit for receiving indication signals from said sensing and delay circuits, said indication signals indicative of whether said predetermined period of time has elapsed and said voltage levels of said phases have met said threshold value.

2. The three phase supervisory circuit of claim 1, wherein said predetermined time period is approximately between one and two seconds in duration.

3. The three phase supervisory circuit of claim 1, wherein said threshold value is about 12 volts.

4. The three phase supervisory circuit of claim 1, wherein said indication signals represents at least one condition selected from the group consisting of:
a first positive indication that said input AC signal meets the threshold value;
a second positive indication that said predetermined time period elapsed;
a first negative indication that said input AC signal does not meet the threshold value; and
a second negative indication that said predetermined period of time does not elapse.

5. The three phase supervisory circuit of claim 1, wherein said predetermined period of time provides for stabilization of capacitors in said three phase circuit upon initially powering said three phase supervisory circuit.

6. The three phase supervisory circuit of claim 4, wherein in response to receiving said first and second positive indication signals said activation circuit outputs an AC power signal.

7. The three phase supervisory circuit of claim 6, wherein each of said sensing circuits has to detect a proper voltage level in a respective phase before a positive indication is provided to said activation circuit.

8. The three phase supervisory circuit of claim 1, further comprising a contactor coil connected to said activation circuit and a plurality of ground fault circuit interrupter (GFCI) receptacles.

9. The three phase supervisory circuit of claim 8, wherein said GFCI receptacles are protected from AC faults via said three phase supervisory circuit.

10. The three phase supervisory circuit of claim 1, wherein said three phase supervisory circuit operates as a tester for allowing testing of AC power signals.

11. The three phase supervisory circuit of claim 1, wherein said fault conditions comprise at least one of a phase reversal, a phase loss and undesirable changes in a phase voltage level.

12. A method for detecting ground fault conditions in an input AC power signal via a three phase supervisory circuit, the method comprising:
detecting a voltage level for three phases of said AC input power signal;
comparing said detected phase voltage levels to a threshold value;
delaying operation of said three phase supervisory circuit for a predetermined period; and
providing results from said steps of comparing and delaying to an activation circuit.

13. The method of claim 12, wherein said predetermined period is approximately between one and two seconds in duration.

14. The method of claim 13, wherein said predetermined period occurs each time said three phase supervisory circuit is initially powered.

15. The method of claim 12, wherein said threshold value is about 12 volts.

16. The method of claim 12, further comprising:
providing an output AC signal upon a determination that no fault conditions were found in said AC input signal.
